(19) United States
(12) Patent Application Publication
(10) Pub. No.: US 2026/0008158 A1
(43) Pub. Date: Jan. 8, 2026

(54) WRENCH FOR OIL FIELD PIPELINE CHOKE BEAN/SEAT WRENCH

(71) Applicant: John Mondragon, Williston, ND (US)

(72) Inventor: John Mondragon, Williston, ND (US)

(21) Appl. No.: 18/766,135

(22) Filed: Jul. 8, 2024

(51) Int. Cl. B25B 13/50

(52) U.S. Cl. CPC B25B 13/5025

(57) ABSTRACT

A wrench for a pipeline choke bean/seat wrench includes an interface that defines an axis along which the body of the choke bean/seat wrench is receivable; and a handle that extends from the interface.

### CROSS REFERENCE TO RELATED APPLICATION[S]

None.

### BACKGROUND

The present disclosure relates to a wrench, and more specifically to wrench for operation of a pipeline choke bean/seat wrench.

A choke valve is a type of flow control valve that is used to regulate the flow of fluids, such as gases or liquids, in a pipeline. In addition, choke valves are also used in many other process industries, such as power generation, chemical, and water treatment.

Choke valves are typically used in the oil and gas industry to control the flow of well fluids, such as oil or natural gas, from a wellhead to a production facility. The valve is designed to reduce the flow rate by creating a restriction in the pipeline, which can be adjusted to achieve the desired flow rate.

A choke bean is a fixed choke used to control fluid flow through the choke valve. The choke bean is mounted near the Christmas tree, which is a set of valves and fittings at the top of a well to control production or flow. Christmas trees are available in a wide range of sizes and configurations, such as low- or high-pressure capacity and single- or multiple-completion capacity. The choke bean is manufactured precisely to a choke diameter as all fluid flows therethrough. The choke beans are available in different sizes and are identified by choke diameter.

The choke includes a replaceable bean usually made of hardened steel/ceramic or stainless steel/tungsten carbide or similar durable material. High pressure gas/oil, with abrasive sand minerals passes through the choke at high speed causing rapid wear such that the choke bean may often need to be replaced quickly.

### SUMMARY

A wrench for a pipeline choke bean/seat wrench according to one disclosed non-limiting embodiment of the present disclosure includes an interface that defines an axis along which the body of the choke bean/seat wrench is receivable; and a handle that extends from the interface.

A further embodiment of any of the foregoing embodiments of the present disclosure includes that the interface is polyfoil that matches the body of the choke bean/seat wrench.

A further embodiment of any of the foregoing embodiments of the present disclosure includes that the interface is a dodecafoil that matches the body of the choke bean/seat wrench.

A further embodiment of any of the foregoing embodiments of the present disclosure includes that the handle extends at an angle to the interface.

A further embodiment of any of the foregoing embodiments of the present disclosure includes that the angle is 15 degrees.

A further embodiment of any of the foregoing embodiments of the present disclosure includes that the wrench is manufactured of a chrome plated steel alloy.

A further embodiment of any of the foregoing embodiments of the present disclosure includes that the wrench weighs between 1.5-1.84 lbs.

A further embodiment of any of the foregoing embodiments of the present disclosure includes that the interface has a thickness of 1⅜ inches along the axis.

A further embodiment of any of the foregoing embodiments of the present disclosure includes that the handle comprises a 15-degree bend at 1.25 inches from that axis.

A wrench for a pipeline choke bean/seat wrench according to one disclosed non-limiting embodiment of the present disclosure includes an interface that defines a dodecafoil along an axis through which the body of the choke bean/seat wrench is receivable, the interface has a thickness of 1⅜ inches along the axis; and a handle portion that extends from the interface perpendicular to axis; and an angled handle portion that extends from the handle portion at an angle of about 15 degrees.

A further embodiment of any of the foregoing embodiments of the present disclosure includes that the wrench is manufactured of a chrome plated steel alloy.

A further embodiment of any of the foregoing embodiments of the present disclosure includes that the wrench weighs between 1.5-1.84 lbs.

A method of adjusting a choke valve according to one disclosed non-limiting embodiment of the present disclosure includes engaging a pipeline choke bean/seat wrench with a choke; engaging a wrench with the pipeline choke bean/seat wrench, the wrench comprising an interface that defines a dodecafoil along an axis through which a body of the choke bean/seat wrench is receivable; and rotating the wrench to thereby rotate the pipeline choke bean/seat wrench about the axis to adjust the choke.

A further embodiment of any of the foregoing embodiments of the present disclosure includes that the choke comprises a choke bean.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic view of a wrench for a pipeline choke bean/seat wrench of a choke valve according to one disclosed non-limiting embodiment.

FIG. 2 is a perspective view of an example pipeline choke bean/seat wrench mounted to an example choke.

FIG. 3 is a perspective view of an example pipeline choke bean/seat wrench mounted to an example choke within an example valve body.

FIG. 4 is a side view of a wrench mounted to an example pipeline choke bean/seat wrench.

FIG. 5 is a top view of the wrench.

FIG. 6 is an expanded top view of the wrench showing the closed polyfoil shaped opening which engages the example pipeline choke bean/seat wrench.

### DETAILED DESCRIPTION

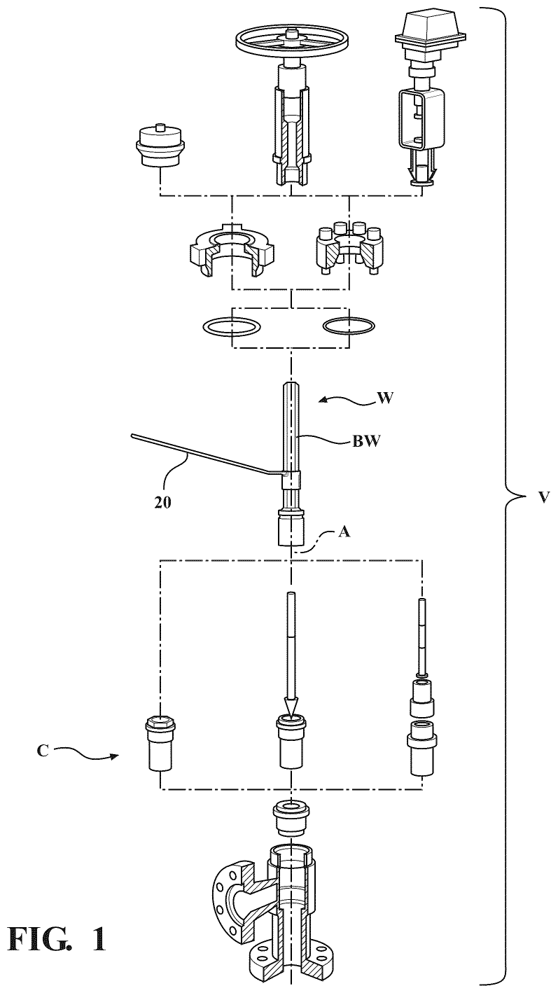

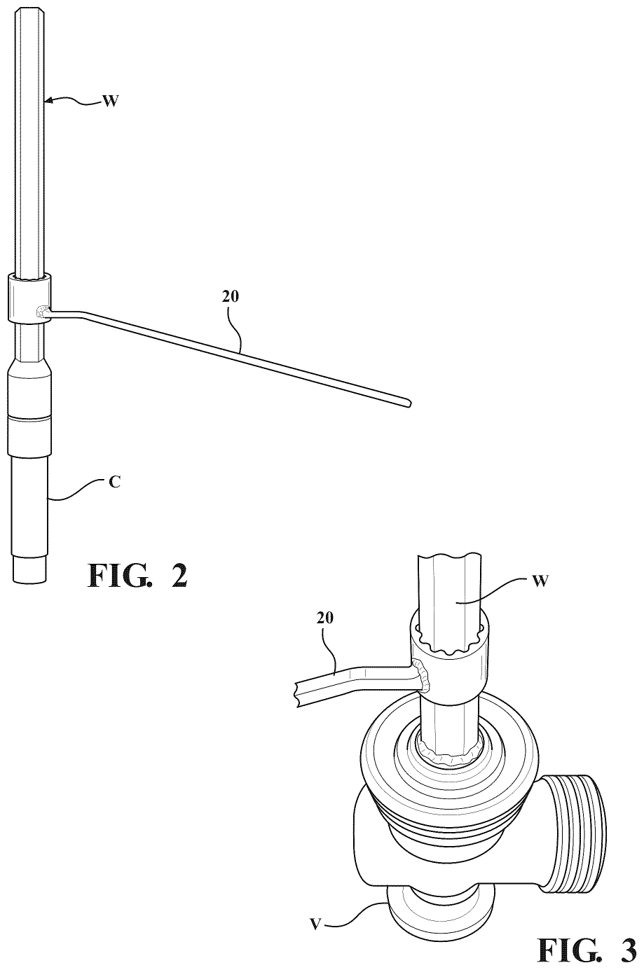

FIG. 1 schematically illustrates a wrench 20 that is used to facilitate rotation of a pipeline choke bean/seat wrench W to adjust a choke C (FIG. 2) of a choke valve V (FIG. 3). The wrench 20 may be manufactured of a chrome plated steel alloy. The wrench 20 may weigh between 1.5-1.84 lbs. which facilitates the ability of an operator to finely control torque as compared to a typical box wrench which is too light to adequately control the torque.

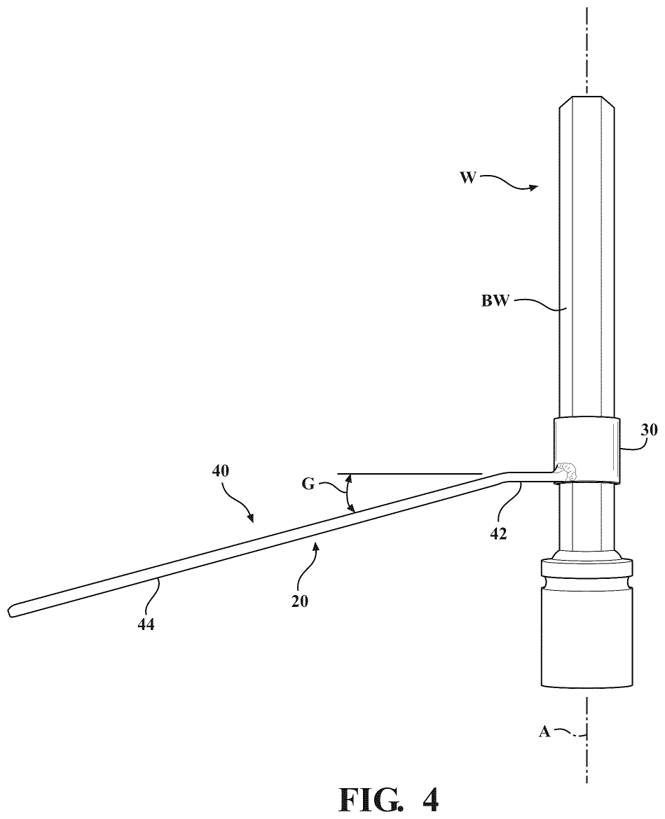

With reference to FIG. 4, the wrench 20 generally includes an interface 30 to surround a body BW of the pipeline choke bean/seat wrench W (FIG. 4) and a handle 40 that extends from the interface 30.

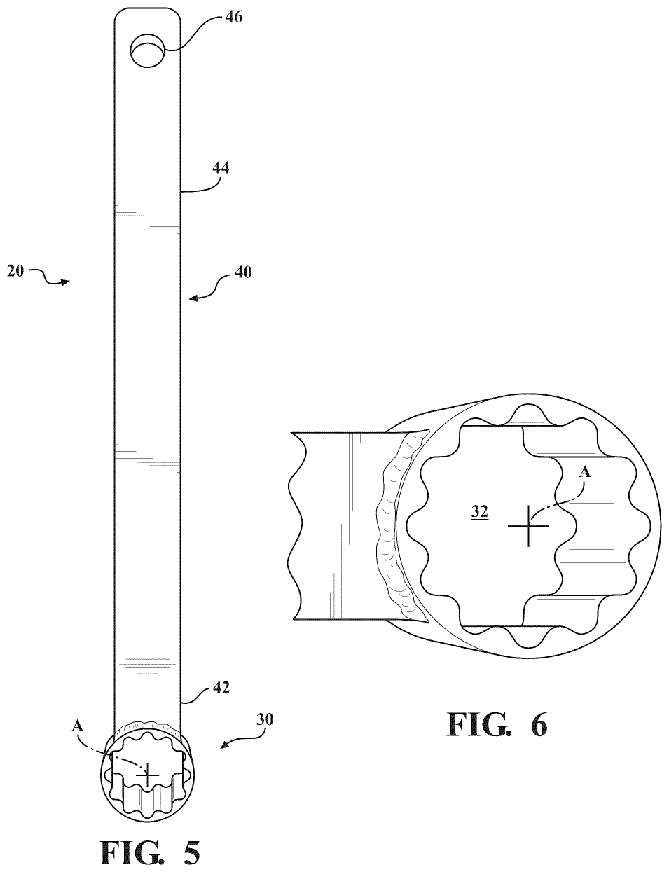

The interface 30 defines an axis A. The interface 30 may be a closed polyfoil shaped opening 32 (FIGS. 5 and 6) that closely matches the polyfoil body BW of the pipeline choke bean/seat wrench W. In one embodiment, the closed polyfoil shaped opening 32 may include twelve (12) semi-circular recesses to essentially form a dodecafoil that exactly match that of the body BW.

The closed polyfoil shaped opening 32 assures that the wrench 20 will not slip off of the pipeline choke bean/seat wrench W given the necessity to rotate the choke wrench 20 very quickly as the choke is often adjusted during flowback of the well to control downstream pressure and flow rates. The closed polyfoil shaped opening 32 allows the bean to be changed as fast as possible in a safe manner as compared to an open-end wrench which may disengage and fall off when rotating the choke wrench.

In one embodiment, the interface 30 has a thickness of 1⅜ inches. This thicker interface 40 prevents the interface from stripping the pipeline choke bean/seat wrench W as compared to typical box wrench which often has a thickness of 0.25-0.5″. The pipeline choke bean/seat wrench W are typically sized at either 1″ or 1 1/16″ such that the interface 30 can fit both types.

In one embodiment, the handle 40 extends from the interface 30 by about 12 inches. The handle 40 may include a 15-degree bend at 1.25″ from axis A of the interface 30. That is, the handle 40 includes a handle portion 42 perpendicular to axis A of the interface 30 and an angled handle portion 44 that defines an angle G of about 15 degrees which facilitates rotation as the handle is flared away from manifold.

An aperture 46 may be located in the angled handle portion 44 opposite the handle portion 42. The angled handle portion 44 allows for maximum rotation of the bean irrespective of the pipe (choke “T”) in which the open end of the choke T flares out to clear the choke “T” as the wrench 20 is rotated around a horizontal axis. The opening of the choke T and the bean wrench allows the tool 20 to take advantage of the space in the choke T to obtain the best rotation and efficient operation without concerns for the wrench 20 disengaging upon rotation.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason, the appended claims should be studied to determine true scope and content.

What is claimed:

1. A wrench for a pipeline choke bean/seat wrench, comprising:
an interface that defines an axis along which the body of the choke bean/seat wrench is receivable; and
a handle that extends from the interface.

2. The wrench as recited in claim 1, wherein the interface is polyfoil that matches the body of the choke bean/seat wrench.

3. The wrench as recited in claim 1, wherein the interface is a dodecafoil that matches the body of the choke bean/seat wrench.

4. The wrench as recited in claim 1, wherein the handle extends at an angle to the interface.

5. The wrench as recited in claim 4, wherein the angle is 15 degrees.

6. The wrench as recited in claim 1, wherein the wrench is manufactured of a chrome plated steel alloy.

7. The wrench as recited in claim 1, wherein the wrench weighs between 1.5-1.84 lbs.

8. The wrench as recited in claim 1, wherein the interface has a thickness of 1⅜ inches along the axis.

9. The wrench as recited in claim 1, wherein the handle comprises a 15-degree bend at 1.25 inches from that axis.

10. A wrench for a pipeline choke bean/seat wrench, comprising:
an interface that defines a dodecafoil along an axis through which the body of the choke bean/seat wrench is receivable, the interface has a thickness of 1⅜ inches along the axis;
a handle portion that extends from the interface perpendicular to axis; and
an angled handle portion that extends from the handle portion at an angle of about 15 degrees.

11. The wrench as recited in claim 10, wherein the wrench is manufactured of a chrome plated steel alloy.

12. The wrench as recited in claim 11, wherein the wrench weighs between 1.5-1.84 lbs.

13. A method of adjusting a choke valve, comprising:
engaging a pipeline choke bean/seat wrench with a choke;
engaging a wrench with the pipeline choke bean/seat wrench, the wrench comprising an interface that defines a dodecafoil along an axis through which a body of the choke bean/seat wrench is receivable; and
rotating the wrench to thereby rotate the pipeline choke bean/seat wrench about the axis to adjust the choke.

14. The method as recited in claim 13, wherein the choke comprises a choke bean.
